(19) United States
(12) Patent Application Publication
(10) Pub. No.: US 2024/0270188 A1
(43) Pub. Date: Aug. 15, 2024

(54) STARTUP METHODS IN BATTERY-LESS AUXILIARY LOW VOLTAGE BUS

(71) Applicant: GM Global Technology Operations LLC, Detroit, MI (US)

(72) Inventors: Mohamed Ahmed Kamel Ahmed, Birmingham, MI (US); Chandra S. Namuduri, Troy, MI (US); Muhammad Hussain Alvi, Troy, MI (US); Suresh Gopalakrishnan, Troy, MI (US)

(21) Appl. No.: 18/169,439

(22) Filed: Feb. 15, 2023

(51) Int. Cl. B60R 16/033

(52) U.S. Cl. CPC B60R 16/033

(57) ABSTRACT

A vehicle, wakeup circuit and method of operating the vehicle. The vehicle includes a high voltage bus. The wakeup circuit includes an enable circuit electrically isolated from a high voltage bus. A key-on signal is received at the enable circuit. A wakeup signal is generated at the enable circuit in response to the key-on signal. An electrical load is activated in response to the wakeup signal.

### INTRODUCTION

The subject disclosure relates to methods for waking an electrical load of a vehicle and, in particular, to a system and method for generating a startup sequence using low voltage power supplies.

An electrical vehicle includes a high voltage battery and a low voltage battery to provide power to its operations. In general, the high voltage battery can have a voltage in the range of +400V to +800V and is used to power the motor of the vehicle. The low voltage battery can have a voltage in the range of +48 V and is used to power auxiliary components of the vehicle, such as windows, entertainments systems, and non-essential processors, etc., including powered wakeup circuits for these electrical loads. Current vehicle designs are proposed in which the low voltage battery is removed altogether. However, having a wakeup circuit operate off of a high voltage line is a power drain to the vehicle. Accordingly, it is desirable to provide a wakeup circuit that can perform wakeup operations off an ultra-low voltage power source.

### SUMMARY

In one exemplary embodiment, a method of operating a vehicle is disclosed. A key-on signal is received at an enable circuit of the vehicle, wherein the enable circuit is electrically isolated from a high voltage bus of the vehicle via a DC/DC converter. A wakeup signal is generated at the enable circuit in response to the key-on signal. An electrical load is activated in response to the wakeup signal.

In addition to one or more of the features described herein, the DC/DC converter is in parallel with the high voltage bus of the vehicle. The method further includes providing power to the enable circuit using a wakeup power source having a limited energy storage capacity at a voltage of less than about 12 volts. The wakeup power source is one of a low voltage side of the DC/DC converter, a coin cell battery, a AA battery, a AAA battery, an energy harvesting device, and a remote power source outside of the vehicle. The method further includes maintaining a charge at the wakeup power source using one of a charger and a secondary-side controlled DC/DC converter having a multiport DC/DC converter. The method further includes providing the key-on signal to the enable circuit via at least one of induction through a transmitter coil and a receiver coil and a signal transmitted from a hand-held device to a self-powered cell monitoring unit. The method further includes operating the enable circuit to perform one of switching from an ultra-low power state to a deep sleep state when an electrical load is enabled and switching from the deep sleep state to the ultra-low power state when the electrical load is enabled.

In another exemplary embodiment, a wakeup circuit for a vehicle is disclosed. The wakeup circuit includes a DC/DC converter and an enable circuit for generating a wakeup signal in response to a key-on signal, wherein the enable circuit is electrically isolated from a high voltage bus of the vehicle via the DC/DC converter.

In addition to one or more of the features described herein, DC/DC converter is electrically coupled to the enable circuit, is connected to the high voltage bus of the vehicle and isolates a low voltage side from the high voltage bus. The wakeup circuit further includes a wakeup power source for providing power to the enable circuit, wherein a limited energy storage capacity of the wakeup power source at a voltage of less than about 12 volts. The wakeup power source is one of a low voltage side of the DC/DC converter, a coin cell battery, a AA battery, a AAA battery, an energy harvesting device, and a remote power source outside of the vehicle. The wakeup circuit further includes a device for maintaining a charge at the wakeup power source, wherein the device is one of a charger, a secondary DC/DC converter having a multiport DC/DC converter, and cell monitoring unit. The wakeup circuit further includes a wireless transmission circuit including at least one of a transmitter coil and a receiver coil for providing the key-on signal to the enable circuit via induction and a self-powered cell monitoring unit configured to receive the key-on signal from a hand-held device. The enable circuit operates by one of switching from an ultra-low power state to a deep sleep state when an electrical load is enabled and switching from the deep sleep state to the ultra-low power state when the electrical load is enabled.

In yet another exemplary embodiment, a vehicle is disclosed. The vehicle includes a high voltage bus for providing power to the vehicle, a DC/DC converter, and an enable circuit for generating a wakeup signal in response to a key-on signal, wherein the enable circuit is electrically isolated from the high voltage bus via the DC/DC converter.

In addition to one or more of the features described herein, the DC/DC converter is electrically coupled to the enable circuit and is in parallel with the high voltage bus of the vehicle. The vehicle further includes a wakeup power source with limited capacity for providing power to the enable circuit, wherein the wakeup power source voltage potential is less than about 12 volts. The vehicle further includes a device for maintaining a charge at the wakeup power source, wherein the device is one of a charger, a secondary DC/DC converter having a multiport DC/DC converter, and cell monitoring unit. The vehicle further includes at least one of a wireless transmission circuit including a transmitter coil and a receiver coil for providing the key-on signal to the enable circuit via induction and a self-powered cell monitoring unit configured to receive the key-on signal from a hand-held device. The enable circuit operates by one of switching from an ultra-low power state to a deep sleep state when an electrical load is enabled and switching from the deep sleep state to the ultra-low power state when the electrical load is enabled.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle operable using the startup methods disclosed herein;

FIG. 2 shows a schematic diagram of a power control unit of the vehicle, in an illustrative embodiment;

FIG. 3 shows a schematic diagram of a wakeup circuit of the power control unit and various downstream components, in a first embodiment;

FIG. 4 is a schematic diagram showing the downstream components of the wakeup circuit, in another embodiment.

FIG. 5 shows timelines illustrating operation of the wakeup circuit of FIG. 3;

FIG. 6 shows a schematic diagram of the wakeup circuit in a second embodiment;

FIG. 7 shows timelines illustrating operation of the wakeup circuit shown in the second embodiment of FIG. 6;

FIG. 8 shows a schematic diagram of the wakeup circuit in a third embodiment;

FIG. 9 shows a secondary-side controlled DC/DC converter suitable for charging a wakeup power source in a fourth embodiment of the wakeup circuit; and

FIG. 10 shows a schematic diagram of a wireless transmission circuit for power transfer to the wakeup circuit, in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, FIG. 1 shows a vehicle 100 operable using the startup methods disclosed herein. In various embodiments, the vehicle 100 is an electric vehicle. The vehicle 100 includes a high voltage power source 102, a power control unit 104 and one or more electrical loads 106. The high voltage power source 102 is electrically coupled to the power control unit 104 via a high voltage bus 108, and the power control unit 104 is electrically coupled to the one or more electrical loads 106 via a low voltage bus 110. The high voltage power source 102 can be a battery or other power source having a voltage in an operating range from about +400 Volts to +800 Volts. However, other operating ranges can be used in alternative embodiments, such a voltage within a range between about +100 Volts and about +950 Volts, including +200 Volts, +400 Volts, +600 Volts, +800 Volts, a combination thereof, or other suitable high voltages. The power control unit 104 distributes power from the high voltage power source 102 to the one or more electrical loads 106. The power control unit 104 can include one or more converters for converting high voltage along the high voltage bus 108 to a low voltage along the low voltage bus 110. In a non-limiting embodiment, the low voltage can be in a range of about +48 volts. However, other low voltage values can be used in alternative embodiments, such as a voltage in a range between about +5 Volts and about +60 Volts. The power control unit 104 can also include components for performing additional control operations of the vehicle 100, such as for controlling a wake mode/sleep mode of the one or more electrical loads 106 by sending a signal across a wakeup line 112. The one or more electrical loads 106 can include, for example, a window controller, a radio or entertainment system, an air conditioning unit, a lighting system, an auxiliary processor, controllers for the high voltage source operation, etc.

The vehicle further includes a controller 114 suitable for controlling various operations at the vehicle 100, including controlling a startup sequence for one or more electrical loads 106. The controller 114 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 114 may include a non-transitory computer-readable medium that stores instructions which, when processed by one or more processors of the controller 114, implement a method of waking up the one or more electrical loads 106 according to one or more embodiments detailed herein.

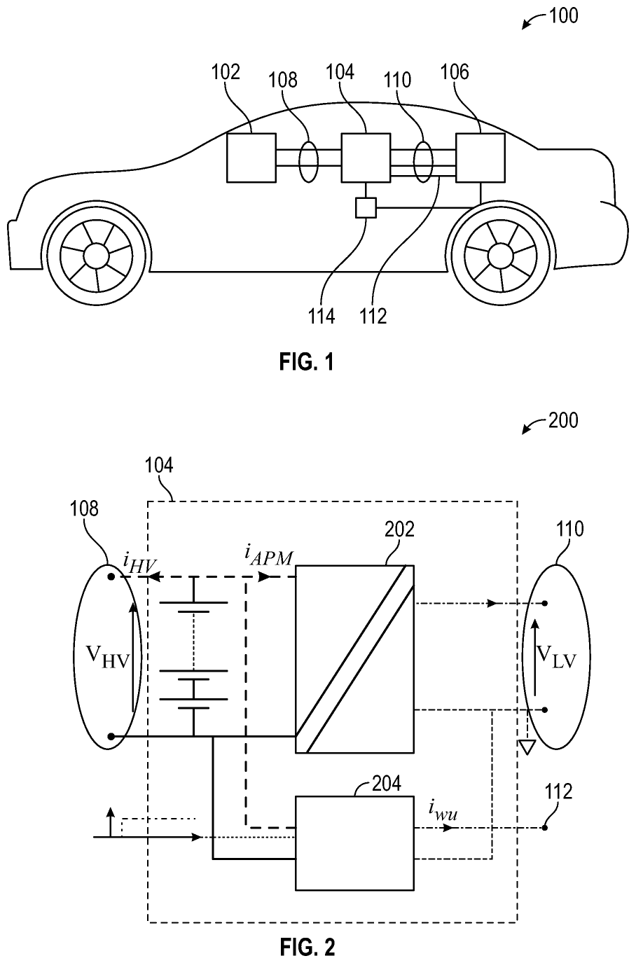

FIG. 2 shows a schematic diagram 200 of the power control unit 104, in an illustrative embodiment. The power control unit 104 includes an auxiliary power module (APM) 202 and a wakeup circuit 204. The APM 202 is connected to the high voltage bus 108 and the low voltage bus 110 and can include a DC/DC converter (direct current to direct current converter) that steps down the high voltage to a low voltage. The wakeup circuit 204 is connected to the high voltage bus 108 and is electrically in parallel with the APM 202. The wakeup circuit 204 outputs a wakeup current i_{wu} that is sent along a wakeup line 112 to the one or more electrical loads 106 to activate them.

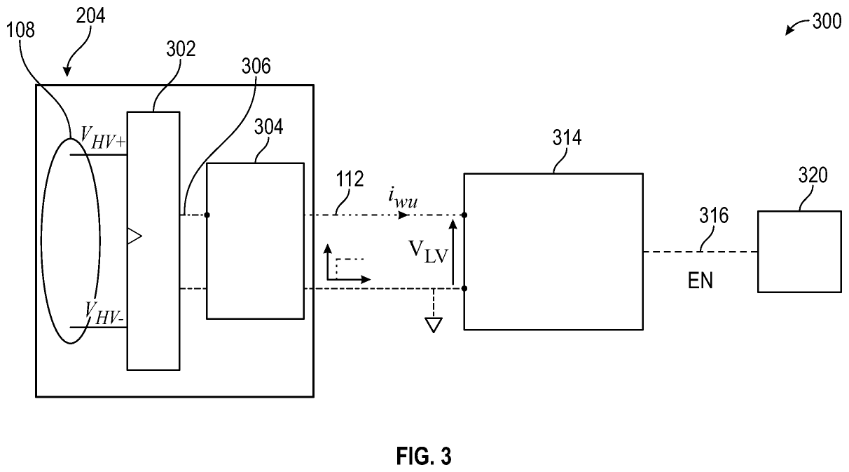

FIG. 3 shows a schematic diagram 300 of the wakeup circuit 204 of the power control unit 104 and various downstream components, in a first embodiment. The wakeup circuit 204 includes an isolated DC/DC converter 302 and an enable circuit 304. The isolated DC/DC converter 302 is coupled to the high voltage bus 108 and provides isolated low voltage output to the enable circuit 304 across LV lines 306. The low voltage output can be about +12V. The isolated DC/DC converter 302 electrically isolates the enable circuit 304 from the high voltage bus 108. The enable circuit 304 can receive a Key-On signal and transmits a wakeup signal i_{wu} along a wakeup line 112 to an isolator 314. The isolator 314 can be a galvanic isolator or an optical isolator, in various embodiments. The isolator 314 responds to the wakeup signal i_{wu} by sending an enable signal EN 316 to a bias power supply 320 for an electrical load or subsystem.

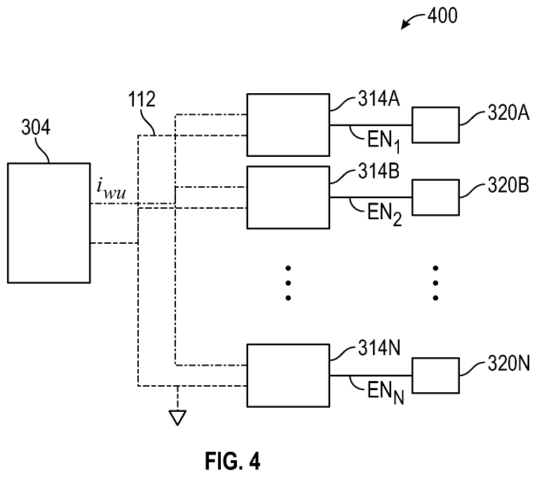

FIG. 4 is a schematic diagram 400 showing the downstream components of the wakeup circuit 204, in another embodiment. The downstream components include a plurality of isolators 314A-N and a plurality of bias power supplies 320A-N. Each isolator is coupled to a respective bias power supply and provides an enable signal EN₁, . . . , EN_{N} to the respective bias power supply upon receipt of the wakeup signal i_{wu}.

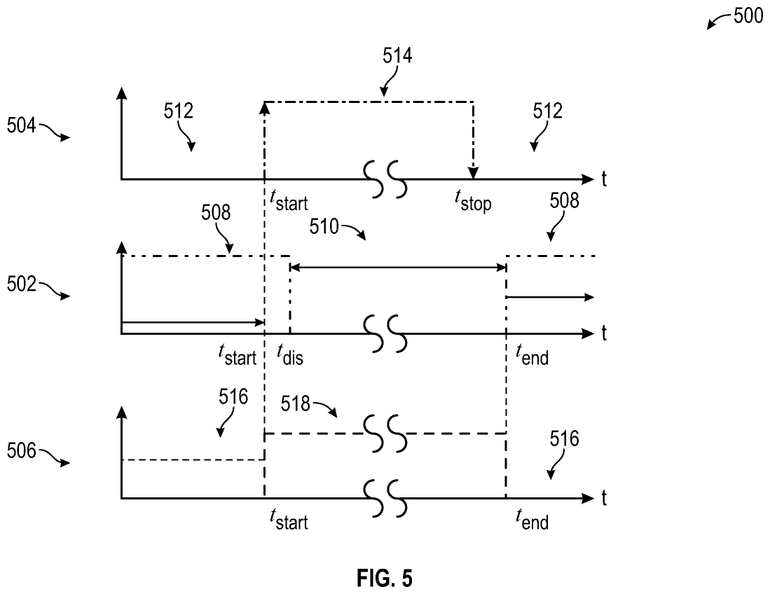

FIG. 5 shows timelines 500 illustrating operation of the wakeup circuit of FIG. 3. Time (t) is shown along the abscissa and power states (ON/OFF) are shown along the ordinate axis. A first timeline 502 (shown as the middle timeline) shows a power state at the LV line 306 between the isolated DC/DC converter 302 and the enable circuit 304. The LV line 306 can be in either an ultra-low power state 508 or a deep sleep state 510 (low quiescent mode). A second timeline 504 (shown as the top timeline) shows a state for a wakeup signal i_{wu} provided on the wakeup line 112 between the enable circuit 304 and the isolator 314. The wakeup signal i_{wu} can be in either an OFF state 512 (no wakeup current i_{wu}) or an ON state 514 (a positive wakeup current i_{wu}). A third timeline 506 (shown as the bottom timeline) illustrates a power state between the isolator 314 and the bias power supply 320. The power can be in either a disabled state 516 or an enabled state 518.

Prior to a start time tₛₜₐᵣₜ, the LV line 306 is in a low power state, the wakeup signal i_{wu} is in an OFF state the bias power supply 320 is disabled. At start time tₛₜₐᵣₜ, a key-on signal is received at the enable circuit 304, placing the wakeup signal i_{wu} in an ON state 514 and the isolator 314 sends an enable signal to place the bias power supply 320 in an enabled state 518. After the start time tₛₜₐᵣₜ, diagnostic procedures are performed to ensure that the bias power supply 320 (and its associated electrical load) are indeed enabled. Once the diagnosis is completed and confirmed, the enable circuit 304 goes into a low quiescent state or deep sleep state 510, as there is no need for a wakeup signal at this time.

At a subsequent stop time tₛₜₒₚ, a key-off signal is received and the wakeup signal i_{wu} returns to the OFF state 512. At a later time (i.e., end time t_{end}), the bias power supply 320 returns to a disabled state 516. As a result, the enable circuit 304 returns to its ultra-low power state 408, in which it is ready to receive the next key-on signal.

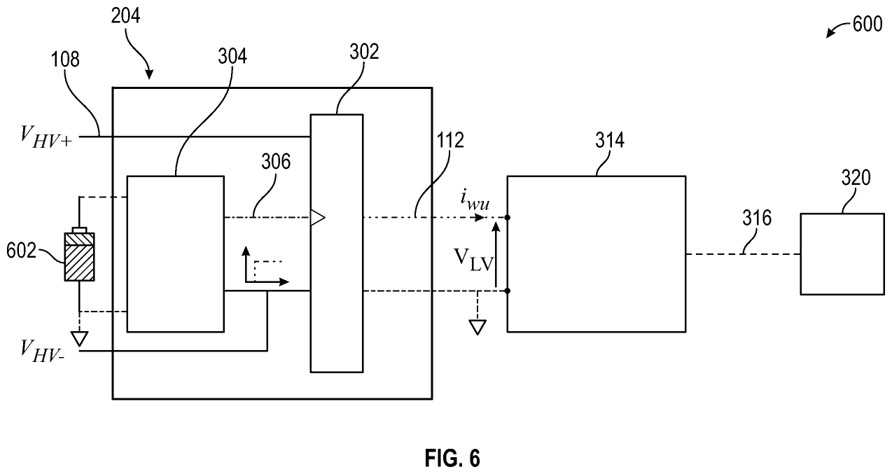

FIG. 6 shows a schematic diagram 600 of the wakeup circuit 204 in a second embodiment. The wakeup circuit 204 includes the isolated DC/DC converter 302 and the enable circuit 304. As opposed to the embodiment of FIG. 3, the enable circuit 304 has two isolated sides, one on a high voltage side of the isolated DC/DC converter 302, and the other side is referred to as the low voltage bus of the vehicle. The enable circuit 304 provides the wakeup signal i_{wu} to the DC/DC converter 302 which then passes it to the isolator 314. The enable circuit 304 is electrically isolated from the high voltage bus 108. A wakeup power source 602 provides power to the enable circuit 304. The wakeup power source 602 can be any power source having a voltage capacity in a range from about +1V to about +12V. In general, the wakeup power source 602 is a limited capacity battery that can be removed from the vehicle for replacement. Exemplary wakeup power sources include, but are not limited to: an AA battery, an AAA battery, a C battery, a D battery, a 9V battery, a CR123A battery (a coin cell battery), a 23A battery, a CR2032 battery, a lithium battery, an alkaline battery, a Carbon-Zinc battery, a Silver-oxide battery, a Zinc-air battery, a Lithium-ion battery, a Nickel-Cadmium (NiCd) battery, and a Nickel metal hydride (NiMH) battery, or similar.

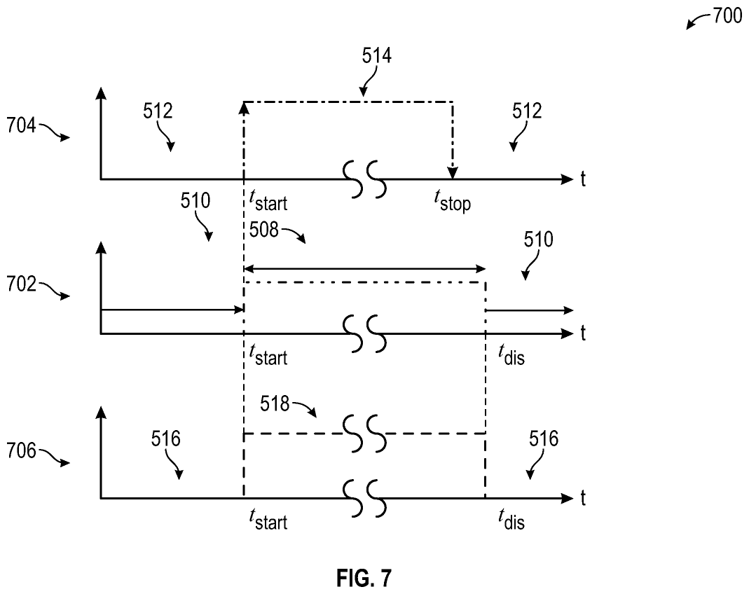

FIG. 7 shows timelines 700 illustrating operation of the wakeup circuit 204 shown in the second embodiment of FIG. 6. Time (t) is shown along the abscissa and power states (ON/OFF) are shown along the ordinate axis. A first timeline 702 shows a power state of the enable circuit 304, which can be either an ultra-low power state 508 or a deep sleep state 510 (low quiescent mode). A second timeline 704 shows a state of a wakeup signal i_{wu} provided on the wakeup line 312 from the isolated DC/DC converter 302 to the isolator 314. The wakeup signal i_{wu} can be in either an OFF state 512 (no wakeup current i_{wu}) or an ON state 514 (a positive wakeup current i_{wu}). A third timeline 706 illustrates a power state between the isolator 314 and the electric load 316. The power state can be in either a disabled state 516 or an enabled state 518.

Prior to a start time tₛₜₐᵣₜ, the enable circuit 304 is in a deep sleep state 510, the wakeup signal i_{wu} is in an OFF state 512 and the bias power supply 320 is in a disabled state 516. At start time tₛₜₐᵣₜ, the key-on signal causes the enable circuit 304 to switch to the ultra-low power state 508 to provide the wakeup signal i_{wu} to the isolated DC/DC converter 302. The wakeup signal i_{wu} thus switches from the OFF state 512 to the ON state 514, causing the bias power supply 320 to switch from a disabled state 516 to an enabled state 518.

At stop time tₛₜₒₚ, a key-off signal is received. The wakeup signal returns to the OFF state 512 while the enable circuit 304 remains in the ultra-low power state 508 and the bias power supplies remain in an enabled state 518. At a later time t_{dis}, the enable circuit 304 returns to the deep sleep state 510 and the bias power supply returns to the disabled state 516.

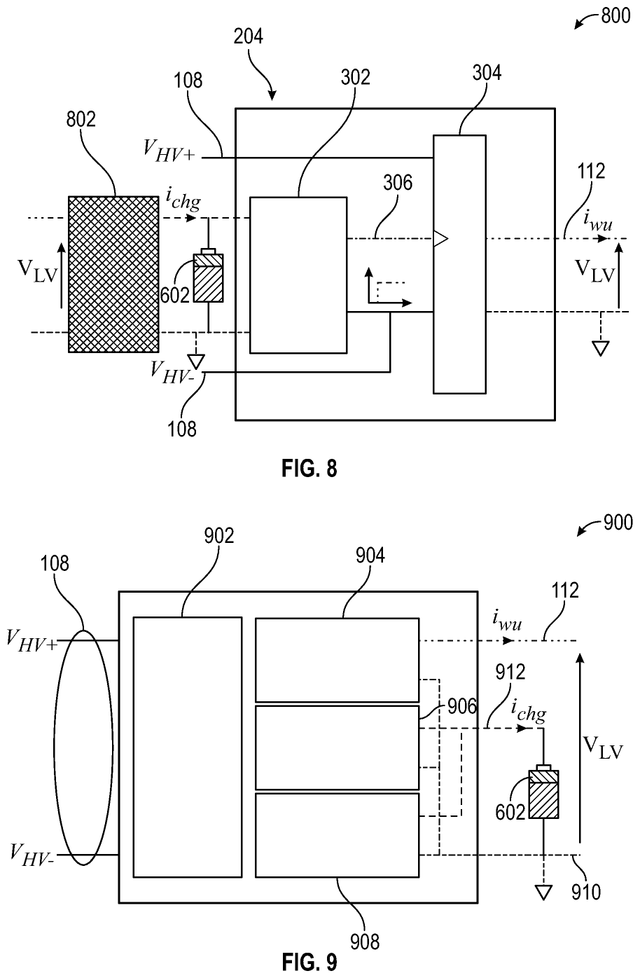

FIG. 8 shows a schematic diagram 800 of the wakeup circuit 204 in a third embodiment. The third embodiment includes the components of the second embodiment as well as a charger 802 coupled to the wakeup power source 602. The charger 802 is connected to low voltage along the wakeup line 112 and provides a charging current i_{chg} to the wakeup power source 602 to maintain a desired state of charge at the wakeup power source 602. The enable circuit 304 is electrically isolated from the high voltage bus 108.

FIG. 9 shows a secondary-side controlled DC/DC converter 900 suitable for charging the wakeup power source 602 in a fourth embodiment of the wakeup circuit 204. The secondary-side controlled DC/DC converter 900 includes a multiport DC/DC converter 902 connecting between the high voltage bus 108 and multiple isolated ports on a low voltage side. An unregulated port 904, a regulated port 906, and a secondary side controller 908 connect to the multiport DC/DC converter 902 on the low voltage side. A negative line 910 connects negative electrodes of the unregulated port 904, the regulated port 906, and the secondary side controller 908 on the low voltage side to a negative end of the wakeup power source 602 that is the low voltage bus reference in the vehicle. A positive line from the unregulated port 904 acts as the wakeup line 112 for providing the wakeup signal i_{wu}. The positive ends of the regulated port 906 and the secondary side controller are connected to a positive end of the wakeup power source 602 via a positive line 912 and provides a charge current i_{cgh} to the wakeup power source. Although, the multiport DC/DC converter 902 is shown as a multi-port flyback DC/DC converter in FIG. 9, other circuit topologies, such as multiport forward DC/DC converters, etc., can be used to perform the function of isolating the low voltage side form the high voltage side.

In a fifth embodiment, a self-powered cell monitoring unit (CMU) or a CMU/RF chip can be used to enable the bias power supplies. By default, the CMU is in a deep sleep state. The CMU listens for the key-on signal from a hand-held device, such as key fob or a mobile phone. The key-on signal wakes the CMU which enables the bias power supply. The DC/DC converter attempts to initiate the low voltage bus at a predetermined initial startup voltage.

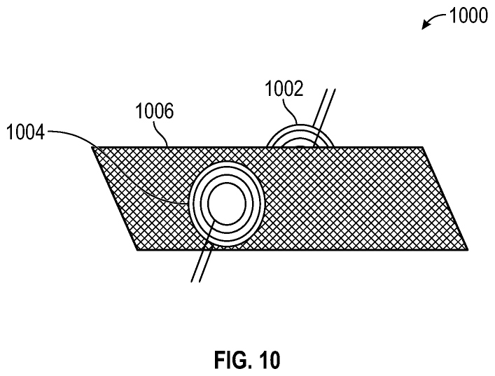

FIG. 10 shows a schematic diagram 1000 of a wireless transmission circuit for power transfer to the wakeup circuit, in another embodiment. The wireless transmission circuit includes a transmitter coil 1002 and a receiver coil 1004. The transmitter coil 1002 and the receiver coil 1004 can be on opposite sides of a body part of the vehicle 100. The transmitter coil 1002 can be within a hand-held device, such as a key fob or a mobile phone. The hand-held device is held within communication range of the receiver coil 1004 and the key-on signal is sent from the transmitter coil 1002 to the receiver coil 1004 and on to the enable circuit 304. Power can also be provided from other energy sources, such as a remote power source, a thermoelectric generator, a piezoelectric device, a solar cell, or other suitable energy harvesting device.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
receiving a key-on signal at an enable circuit of the vehicle, wherein the enable circuit is electrically isolated from a high voltage bus of the vehicle via a DC/DC converter;
generating a wakeup signal at the enable circuit in response to the key-on signal; and
activating an electrical load in response to the wakeup signal.

2. The method of claim 1, further comprising coupling the enable circuit to the DC/DC converter, wherein the DC/DC converter is in parallel with the high voltage bus of the vehicle.

3. The method of claim 2, further comprising providing power to the enable circuit using a wakeup power source having a limited energy storage capacity at a voltage of less than about 12 volts.

4. The method of claim 3, wherein the wakeup power source is one of: (i) a low voltage side of the DC/DC converter; (ii) a coin cell battery; (iii) a AA battery; (iv) a AAA battery; (v) an energy harvesting device; and (vi) a remote power source outside of the vehicle.

5. The method of claim 3, further comprising maintaining a charge at the wakeup power source using one of: (i) a charger; and (ii) a secondary-side controlled DC/DC converter having a multiport DC/DC converter.

6. The method of claim 1, further comprising providing the key-on signal to the enable circuit via at least one of: (i) induction through a transmitter coil and a receiver coil; and (ii) a signal transmitted from a hand-held device to a self-powered cell monitoring unit.

7. The method of claim 1, further comprising operating the enable circuit to perform one of: (i) switching from an ultra-low power state to a deep sleep state when an electrical load is enabled; and (ii) switching from the deep sleep state to the ultra-low power state when the electrical load is enabled.

8. A wakeup circuit for a vehicle, comprising:
a high voltage bus for providing power to the vehicle;
a DC/DC converter;
an enable circuit for generating a wakeup signal in response to a key-on signal, wherein the enable circuit is electrically isolated from the high voltage bus of the vehicle via the DC/DC converter.

9. The wakeup circuit of claim 8, wherein the DC/DC converter electrically coupled to the enable circuit, is connected to the high voltage bus of the vehicle and isolates a low voltage side from the high voltage bus.

10. The wakeup circuit of claim 9, further comprising a wakeup power source for providing power to the enable circuit, wherein a limited energy storage capacity of the wakeup power source at a voltage of less than about 12 volts.

11. The wakeup circuit of claim 10, wherein the wakeup power source is one of: (i) a low voltage side of the DC/DC converter; (ii) a coin cell battery; (iii) a AA battery; (iv) a AAA battery; (v) an energy harvesting device; and (vi) a remote power source outside of the vehicle.

12. The wakeup circuit of claim 10, further comprising a device for maintaining a charge at the wakeup power source, wherein the device is one of: (i) a charger; (ii) a secondary DC/DC converter having a multiport DC/DC converter; and (iii) cell monitoring unit.

13. The wakeup circuit of claim 8, further comprising a wireless transmission circuit including at least one of: (i) a transmitter coil and a receiver coil for providing the key-on signal to the enable circuit via induction; and (ii) a self-powered cell monitoring unit configured to receive the key-on signal from a hand-held device.

14. The wakeup circuit of claim 8, wherein the enable circuit operates by one of: (i) switching from an ultra-low power state to a deep sleep state when an electrical load is enabled; and (ii) switching from the deep sleep state to the ultra-low power state when the electrical load is enabled.

15. A vehicle, comprising:
a high voltage bus for providing power to the vehicle;
a DC/DC converter; and
an enable circuit for generating a wakeup signal in response to a key-on signal, wherein the enable circuit is electrically isolated from the high voltage bus via the DC/DC converter.

16. The vehicle of claim 15, wherein the DC/DC converter electrically coupled to the enable circuit and is in parallel with the high voltage bus of the vehicle.

17. The vehicle of claim 16, further comprising a wakeup power source with limited capacity for providing power to the enable circuit, wherein the wakeup power source voltage potential is less than about 12 volts.

18. The vehicle of claim 17, further comprising a device for maintaining a charge at the wakeup power source, wherein the device is one of: (i) a charger; (ii) a secondary DC/DC converter having a multiport DC/DC converter; and (iii) cell monitoring unit.

19. The vehicle of claim 15, further comprising at least one of: (i) a wireless transmission circuit including a transmitter coil and a receiver coil for providing the key-on signal to the enable circuit via induction; and (ii) a self-powered cell monitoring unit configured to receive the key-on signal from a hand-held device.

20. The vehicle of claim 15, wherein the enable circuit operates by one of: (i) switching from an ultra-low power state to a deep sleep state when an electrical load is enabled; and (ii) switching from the deep sleep state to the ultra-low power state when the electrical load is enabled.
